(19) United States
(12) Patent Application Publication
(10) Pub. No.: US 2021/0160335 A1
(43) Pub. Date: May 27, 2021

(54) CONTEXTUALLY-BASED PRESENCE STATUS

(71) Applicant: Microsoft Technology Licensing, LLC, Redmond, WA (US)

(72) Inventors: Vincent Bellet, Kirkland, WA (US); Paul Y. Sim, Seattle, WA (US); Michael H. Hill, Shoreline, WA (US)

(21) Appl. No.: 16/692,531

(22) Filed: Nov. 22, 2019

(51) Int. Cl. H04L 29/08; G06F 9/54; H04L 12/58; G06F 3/0481

(52) U.S. Cl. CPC H04L 67/24; G06F 9/542; G06F 3/0481; H04L 67/306; H04L 51/046; G06F 9/543

(57) ABSTRACT

A system and method perform contextually-based presence status management. A presence monitoring agent determines a first context in which a computing device is being used by a user, and the user may use a communication client to establish a first status for the user's user account. The communication client is configured to receive events or notifications from other communication clients or devices, and present a plurality of response options to the user. The user may then change the user account status to a second status by selecting a response option. The presence monitoring agent then monitors for changes in the context in the operating system to determine whether the user account status should be changed back to the first status.

### TECHNICAL FIELD

The subject matter disclosed herein generally relates to determining and managing a contextually-based presence status for a user. In particular, the subject matter disclosed herein relates to a presence monitoring agent configured to monitor the activity of a user account and suggest one or more reply options for responding to an event or other notification received by a communication client. The presence monitoring agent is also configured to automatically change or revert the status of the user account in response to changes in the operational and/or application context of the user account.

### BACKGROUND

A communication client typically allows a user to communicate with other users using a network, such as a local area network or a wide area network (e.g., the Internet). The user may desire to inform other users of his or her status while connected to the network, such as whether the user is available to communicate or busy with a particular project. Accordingly, the communication client may allow the user to set or establish his or her status using the communication client, which may then be broadcast to other users that are in communication with the user to inform the other users as to the user's current status.

However, there are times when the user's actual status and the user's communicated status are different. Accordingly, the user may be interrupted by other users or events, and the user may prefer not to engage with the other users or the events. In this regard, the user may change his or her status to a second (or different) status than was originally communicated to his or her user network. The communication client may then broadcast this second status to the user's network.

Unfortunately, a person's attention is often devoted to different activities and the user may forget to revert or change the status after this second status was set. For example, the user may have been busy on a project and did want not be disturbed, but then completed the project and was ready to interact with other users. In this case, should the user forget to change or revert his or her status back to a non-busy state or message, other users in the user's network will not know that he or she is ready to interact with other people. This may result in the user missing out on opportunities within the user's network or may result in the user being passed over for a project or other activity.

### SUMMARY

To address these and other problems that arise within the field of online communications, this disclosure provides a presence monitoring agent for automatically reverting or change the status of a user account based on a change the operational and/or application context of the user account.

In one embodiment, this disclosure describes a method for presenting contextually-aware response actions, the method comprising detecting a first change in a first context of a first application assigned to a plurality of predefined applications, wherein a change in context of an application selected from the plurality of predefined applications causes a display of a prompt, causing the display of the prompt based on the detected change in the first context of the first application, wherein the prompt presents one or more prompt options to a user to change a status of a user account associated with the user from a first status value to a second status value, and the status indicates an availability of the user. The method also includes changing the status of the user account, based on an interaction with the displayed prompt, from the first status value to the second status value, detecting a second change in a second context of the first application, changing the status value of the user account from the second status value to the first status value based on the detected second change, and causing a display of the changed status of the user account in another computing device currently displaying the status of the user account.

In another embodiment of the method, the method includes detecting a change in context of a second application that is not assigned to the plurality of predefined applications, and determining, response to the detected change in context of the second application, not to cause a display of the prompt based on the second application not being assigned to the plurality of predefined applications.

In a further embodiment of the method, the method includes determining, in response to the detected change in context of the second application, not to change the status of the user account based on the second application not being assigned to the plurality of predefined applications.

In yet another embodiment of the method, detecting the first change in the first context of the first application comprises determining that a graphical user interface in which the first application is displayed was moved from a first display to a second display.

In yet a further embodiment of the method, detecting the first change in the first context of the first application comprises determining a change in state of the first application.

In another embodiment of the method, the method includes automatically changing the status of the user account from the first status value to the second status value based on the first context, and automatically changing the status of the user account from the second status value to the first statue value based on the second context.

In a further embodiment of the method, the one or more prompt options are selected from a plurality of prompt options based on the detected change in the first context of the first application.

The disclosure also describes a system for presenting contextually-aware response actions, wherein the system includes a computer storage device storing computer-executable instructions, and one or more processors that, having executed the computer-executable instructions, configure a system to perform a plurality of operations comprising detecting a first change in a first context of a first application assigned to a plurality of predefined applications, wherein a change in context of an application selected from the plurality of predefined applications causes a display of a prompt. The plurality of operations also include causing the display of the prompt based on the detected change in the first context of the first application, wherein the prompt presents one or more prompt options to a user to change a status of a user account associated with the user from a first status value to a second status value, and the status indicates an availability of the user. The plurality of operations further comprises changing the status of the user account, based on an interaction with the displayed prompt, from the first status value to the second status value, detecting a second change in a second context of the first application, changing the status value of the user account from the second status value to the first status value based on the detected second change, and causing a display of the changed status of the user account in another computing device currently displaying the status of the user account.

In another embodiment of the system, the plurality of operations further comprises detecting a change in context of a second application that is not assigned to the plurality of predefined applications, and determining, response to the detected change in context of the second application, not to cause a display of the prompt based on the second application not being assigned to the plurality of predefined applications.

In a further embodiment of the system, the plurality of operations further comprises determining, in response to the detected change in context of the second application, not to change the status of the user account based on the second application not being assigned to the plurality of predefined applications.

In yet another embodiment of the system, detecting the first change in the first context of the first application comprises determining that a graphical user interface in which the first application is displayed was moved from a first display to a second display.

In yet a further embodiment of the system, detecting the first change in the first context of the first application comprises determining a change in state of the first application.

In another embodiment of the system, the plurality of operations further comprises automatically changing the status of the user account from the first status value to the second status value based on the first context, and automatically changing the status of the user account from the second status value to the first statue value based on the second context.

In a further embodiment of the system, the one or more prompt options are selected from a plurality of prompt options based on the detected change in the first context of the first application.

This disclosure also describes a system for presenting contextually-aware response actions, wherein the system comprises means for detecting a first change in a first context of a first application assigned to a plurality of predefined applications, wherein a change in context of an application selected from the plurality of predefined applications causes a display of a prompt, and means for causing the display of the prompt based on the detected change in the first context of the first application, wherein the prompt presents one or more prompt options to a user to change a status of a user account associated with the user from a first status value to a second status value, and the status indicates an availability of the user. The system also comprises means for changing the status of the user account, based on an interaction with the displayed prompt, from the first status value to the second status value, means for detecting a second change in a second context of the first application, means for changing the status value of the user account from the second status value to the first status value based on the detected second change, and means for causing a display of the changed status of the user account in another computing device currently displaying the status of the user account.

In another embodiment of the system, the system further comprises means for detecting a change in context of a second application that is not assigned to the plurality of predefined applications, and means for determining, in response to the detected change in context of the second application, not to cause a display of the prompt based on the second application not being assigned to the plurality of predefined applications.

In a further embodiment of the system, the system further comprises means for determining, in response to the detected change in context of the second application, not to change the status of the user account based on the second application not being assigned to the plurality of predefined applications.

In yet another embodiment of the system, the means for detecting the first change in the first context of the first application detect the first change by determining that a graphical user interface in which the first application is displayed was moved from a first display to a second display.

In yet a further embodiment of the system, the means for detecting the first change in the first context of the first application detect the first change by determining a change in state of the first application.

In another embodiment of the system, the system further comprises automatically changing the status of the user account from the first status value to the second status value based on the first context, and automatically changing the status of the user account from the second status value to the first statue value based on the second context.

One of the challenges in allowing users to communicate via a communication application, is that a one user may not know whether another user is available. Accordingly, a user may spend unnecessary computing resources in trying to communicate with the unavailable user. In the aggregate, where hundreds or thousands of users are attempting to communicate with other, unavailable users, the amount of computing resources that may be expended is non-trivial. Examples of computing resources that may be expended include processor cycles (e.g., using processor cycles to interact with a communication application), computer memory (e.g., using computer memory to store an instance of the messages written or sent using the communication application), network bandwidth (e.g., using network bandwidth to send messages to the unavailable user), and other such computing resources. This disclosure addresses the use and expenditure of these resources by describing subject matter directed to the autonomous management of a user's account status, which may switch from an available status to an unavailable status and then back again, depending on which application a user is interacting with and the state of the application.

In addition, this disclosure describes a non-conventional manner for setting or assigning a status value to a user account status. Conventionally, the status value for the user account is manually set by the user, for example, by using a communication application that provides an interface for changing the user account status. In this approach, the user generally determines when the status value should be set and the value that should be assigned to the user account status. For example, the user may change an account status that has an “Available” value to a “Busy” value when the user decides to begin working on a particular project.

However, this disclosure specifies how interactions with a computing device are manipulated to yield a desired result that overrides the routine and conventional sequence of events ordinarily performed in setting a user account status. Instead of manually interacting with a communication application to set the user account status, this disclosure describes systems and methods whereby changes in the context of an application indicate that a change in the user account status is intended. In this regard, when the computing device determines that a change in context has occurred, the computing device may automatically present a prompt to the user that queries whether the user would like to change his or her account status. Thus, unlike a conventional implementation that would expect the user to manually change his or her account status when the user believes he or she may be busy or otherwise occupied, the disclosed systems and methods detect changes in the context of an application in determining whether a change in the user account status is desired.

### BRIEF DESCRIPTION OF THE DRAWINGS

Some embodiments are illustrated by way of example and not limitation in the figures of the accompanying drawings.

FIG. 1 is a block diagram illustrating a networked system that includes various types of computing devices in communication with a communication server, according to an example embodiment.

FIG. 2 illustrates the components of a client device illustrated in FIG. 1, according to an example embodiment.

FIG. 3 illustrates a graphical user interface showing a current status of a user account, in accordance with an example embodiment.

FIG. 4 illustrates the graphical user interface of FIG. 3 with an electronic document displayed in a primary window section, in accordance with an example embodiment.

FIG. 5 illustrates the graphical user interface of FIG. 3, in accordance with an example embodiment, where a secondary window section includes a list of revisions, comments, and/or edits that have been made to an electronic document.

FIG. 6 illustrates the graphical user interface of FIG. 3, in accordance with an example embodiment, where a communication client has received an event or notification from another user.

FIG. 7 illustrates the graphical user interface of FIG. 3, where a user has selected to respond to a prompt shown in FIG. 6, by providing a custom status in a text element of the displayed prompt.

FIG. 8 illustrates the graphical user interface where the custom status entered in FIG. 7 is set for the user account.

FIGS. 9A-9B illustrate a method, in accordance with an example embodiment, for changing the status of a user account in response to a received event or notification.

FIG. 10 illustrates a method, in accordance with an example embodiment, for determining whether to change a current status based on a change in context of an application.

FIG. 11 is a block diagram illustrating components of a machine, according to some example embodiments, able to read instructions from a machine-readable medium (e.g., a machine-readable storage medium or machine-readable storage device) and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

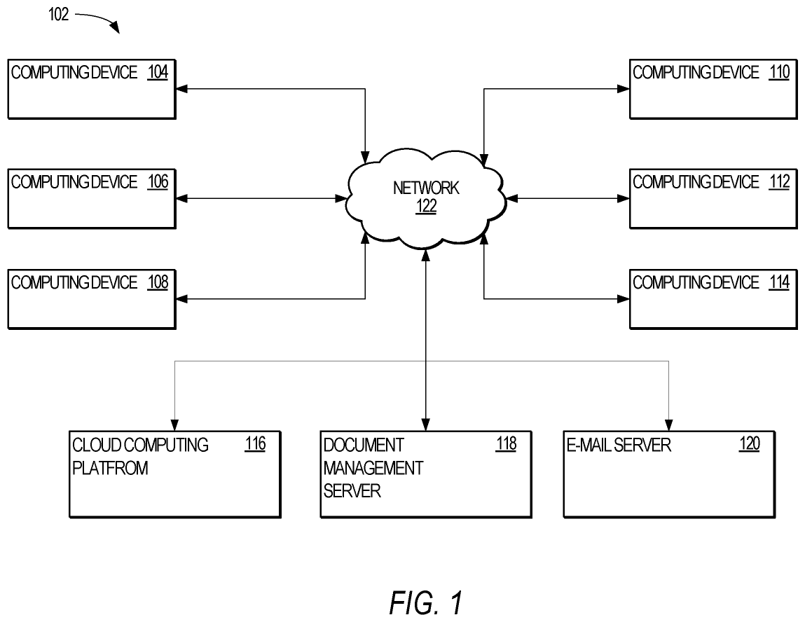

FIG. 1 is a block diagram illustrating a networked system 102 where computing devices 104-114 are in communication with various types of servers and platforms, including a cloud computing platform 116, a document management server 118, and an e-mail server 120. The computing devices 104-114, the cloud computing platform 116, and the servers 118-120 may communicate with each other via the network 122, which may be the Internet or the like. In one embodiment, the cloud computing platform 116, the document management server 118, and the e-mail server 120 facilitate communication sessions among the computing devices 104-114. The computing devices 104-114 may retrieve and/or send data to and from the cloud computing platform 116, the document management server 118, and the e-mail server 120 via the network 122.

The computing devices 104-114 may comprise different types of computing devices. The computing devices include, but are not limited to, a mobile phone, desktop computer, laptop, portable digital assistant (PDA), smart phone, tablet, ultra-book, netbook, laptop, multi-processor system, microprocessor-based or programmable consumer electronic, or any other communication device that a user may utilize to perform various computing tasks (e.g., accessing the Internet, making a phone call, conducting a video conference, etc.). In some embodiments, the computing devices 104-114 may comprise a display or display module (not shown) to display information (e.g., in the form of user interfaces). In further embodiments, the computing devices 104-114 may comprise one or more of touch screens, accelerometers, gyroscopes, cameras, microphones, global positioning system (GPS) devices, and so forth.

The cloud computing platform 116, the document management server 118, and the e-mail server 120 provide multiple services such as communication services, file sharing services, and so forth, to the computing devices 104-114. In one embodiment, the cloud computing platform 116, the document management server 118, and/or the e-mail server 120 facilitate a communication session between two or more of the computing devices 104-114. The communication session may be an audio-only communication session, such as a Voice Over IP (VoIP) phone call, and use various signaling and/or audio protocols for establishing the communication session including, but not limited to, User Datagram Protocol (UDP), Transmission Control Protocol (TCP), Real-Time Transport Protocol (RTP), Real-Time Transport with Control Protocol (RTCP), H.323, Real-Time Streaming Protocol (RTSP), Session Initiation Protocol (SIP), and other such protocols, or combinations thereof. The communication session may also be a text-based session where text messages are communicated between (or among) two or more of the computing devices 104-114. The communication session may also be a video stream (with or without audio) and use similar protocols for establishing the video stream including, but not limited, RTP, RTCP, RTSP, UDP, TCP, and any other protocols or combinations thereof.

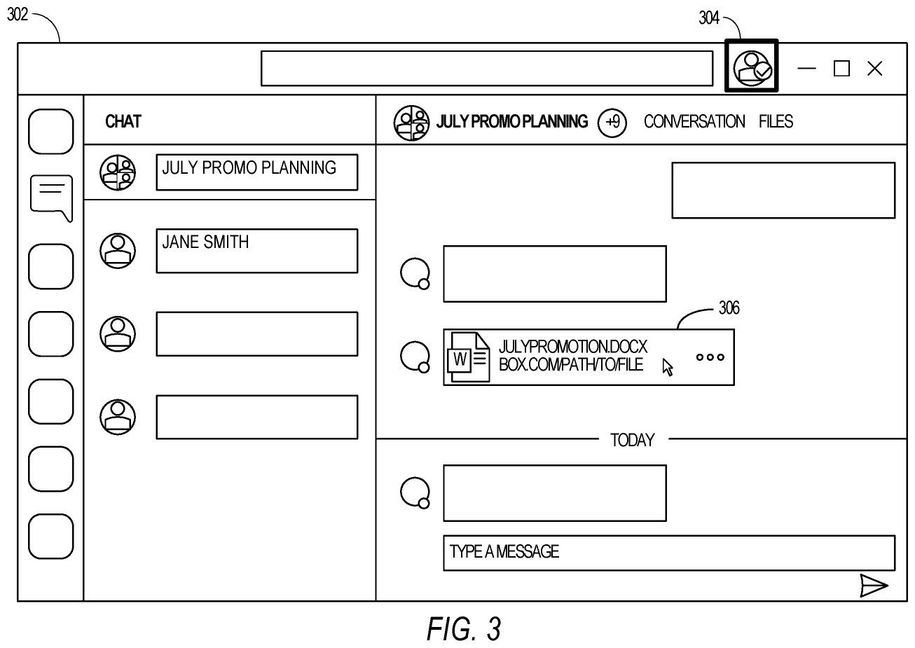

The cloud computing platform 116, the document management server 118, and/or the e-mail server 120 may also provide additional services for the computing devices 104-114, such as a file sharing services, collaboration services, calendaring services, live video streaming services, and other such services or combinations thereof. Each of the services may be associated with event notifications, where an event notification signals to a user account of a particular occurrence associated with one of the services. For example, a calendar event may alert a user account that a scheduled meeting appointment is about to start, a file sharing event may alert a user account that another user account wishes to share and/or display a particular file with the user account, a message event may alert a user account that another user account has sent a message to the user account, and so forth. As discussed below with reference to FIGS. 3-9, a client device may be configured with a communication client that allows a user to manage how the received event is handled or addressed.

The cloud computing platform 116, the document management server 118, and/or the e-mail server 120 may be instantiated as one or more servers. One example of the cloud computing platform 116 is AZURE®, which is provided by the Microsoft Corporation. As known to one of ordinary skill in the art, AZURE®, provides a platform as a service (“PaaS”) that allows for the building, testing, deploying, and managing applications and services through one or more data centers. The cloud computing platform 116 may also provide software as a service (“SaaS”), such Office 365, which the computing devices 104-114 may use to communicate with one another. One example of the document management server 118 is SHAREPOINT®, which is also available from the Microsoft Corporation. As known to one of ordinary skill in the art, SHAREPOINT® is a document management and storage system that also provides various services, such as intranet and social network services, groupware services, and storage services. Finally, one example of the e-mail server 120 is MICROSOFT EXCHANGE SERVER®, also available from the Microsoft Corporation, which one of ordinary skill in the art would know is a mail and calendaring server.

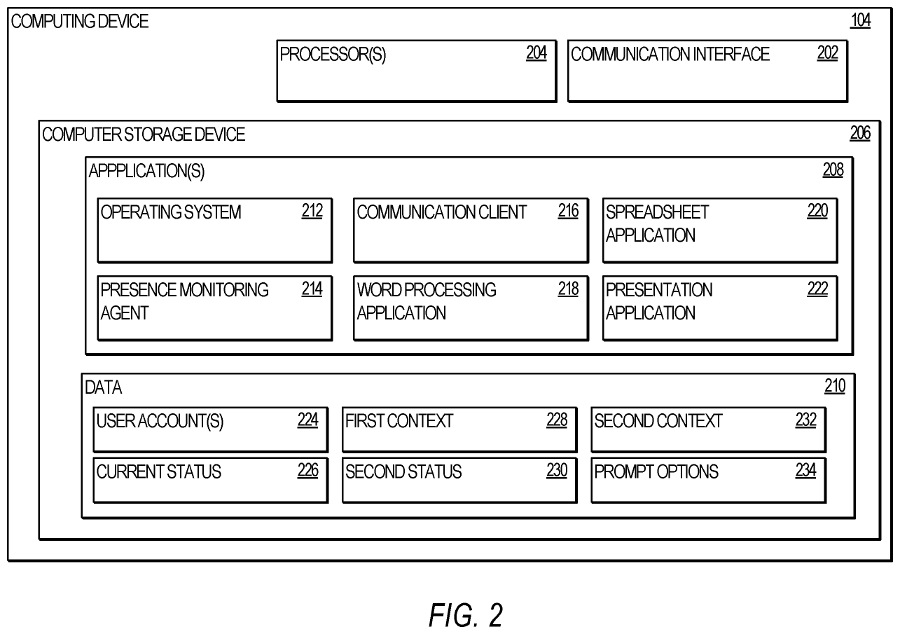

To communicate with the cloud computing platform 116, the document management server 118, the e-mail server 120, and/or the other computing devices 104-114, each of the computing devices 104-114 may instantiate a communication client. The communication client may handle operations associated with one or more of the services provided by the cloud computing platform 116, the document management server 118, and/or the e-mail server 120 such as MICROSOFT TEAMS®. As discussed below with reference to FIG. 2, the communication client further handles and/or instantiates a communication session between two or more of the computing devices 104-114.

As evident from the foregoing description, the cloud computing platform 116, the document management server 118, and/or the e-mail server 120 may implement various applications to provide the aforementioned services to the computing devices 104-114. Furthermore, while FIG. 1 illustrates the cloud computing platform 116, the document management server 118, and/or the e-mail server 120 as individual boxes, one of ordinary skill in the art will appreciate that the cloud computing platform 116, the document management server 118, and/or the e-mail server 120 may be distributed across multiple computing devices and/or servers, including different processors, memories, and so forth.

Although the foregoing paragraph describes an implementation of the cloud computing platform 116, the document management server 118, and/or the e-mail server 120 acting as intermediary servers between the computing devices 104-114, the computing devices 104-114 may communicate among each other without these devices and platform acting as intermediaries. In one embodiment, the cloud computing platform 116 provides awareness and endpoint information for a communication session among two or more of the computing devices 104-114. The cloud computing platform 116 may also initially establish a communication session between the computing devices 104-114.

After establishing the communication session between the computing devices 104-114, network traffic (e.g., audio, video, images, files, etc.) communicated during the communication session may pass through network 122 but may not pass through the cloud computing platform 116. In this implementation, one of the computing devices 104-114 may serve as a hosting device to provide the functionalities that would be provided by the cloud computing platform 116, such as the routing of the network traffic and/or any processing of the video and/or audio streams. In establishing the communication session, the cloud computing platform 116 may select a client device as the hosting device, and then transfer processing of the communication session to the selected hosting device. In one embodiment, the hosting device is selected based on its available computing resources including, but not limited to, CPU speed, available non-volatile memory, available volatile memory, network bandwidth availability, and other such computing resources or combinations thereof.

The computing devices 104-114, the cloud computing platform 116, the document management server 118, and/or the e-mail server 120 may be implemented as a client/server relationship, as a peer-to-peer relationship (e.g., computing devices 104-114 are communicatively connected as peer devices), or a server-to-server relationship (e.g., the computing devices 104-114 are implemented as servers and communicate with each other and/or the cloud computing platform 116, the document management server 118, and/or the e-mail server 120 to provide various services to one another).

The network 122 disposed between the computing devices 104-114 and the cloud computing platform 116, the document management server 118, and/or the e-mail server 120 may include one or more types of networks. For example, the network 122 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a Wi-Fi network, a WiMAX network, another type of network, or a combination of two or more such networks.

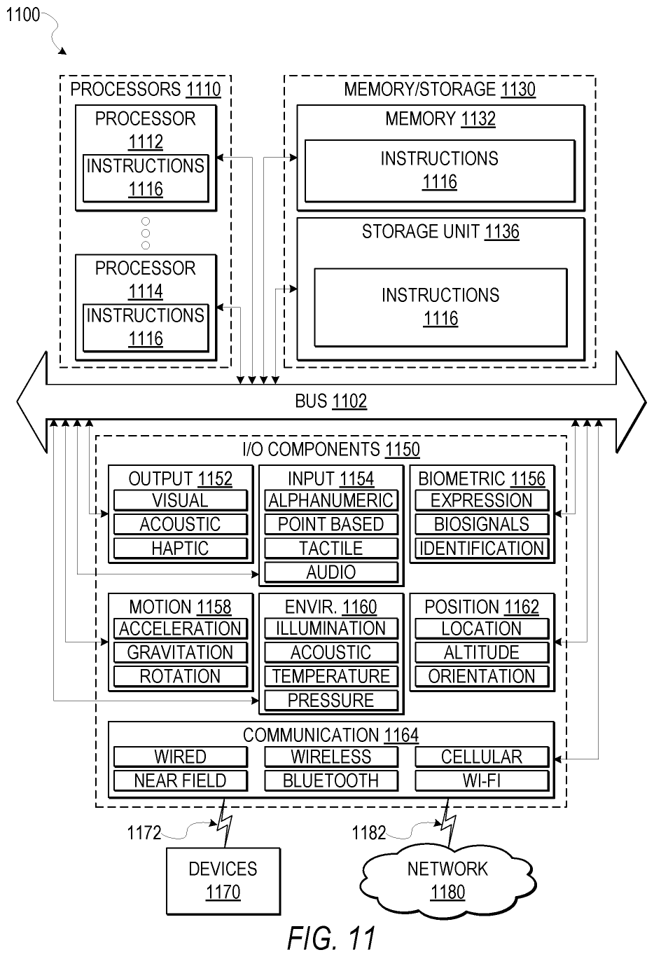

FIG. 2 illustrates the components of the computing device 104 illustrated in FIG. 1, according to an example embodiment. The components illustrated in FIG. 2 may correspond to, or be implemented by, one or more of the components shown in FIG. 11.

As shown in FIG. 2, and in one embodiment, the computing device 104 includes various components 202-210. These components 202-210 include, but are not limited to, a communication interface 202, one or more processor(s) 204, a computer storage device 206, various application(s) 208 and data 210 that may be used by, and/or supports, the application(s) 208.

The various component 202-210 of the computing device 104 may reside on a single device or may be distributed across several devices in various arrangements. The various components 202-210 of the computing device 104 may access one or more computer storage devices for configuration information and/or implementation algorithms, and each of the various components 202-210 may be in communication with one another (e.g., via one or more communication buses or the like). Further, while the components 202-210 of FIG. 2 are discussed in the singular sense, it will be appreciated that in other embodiments multiple instances of the components 202-210 may be employed.

One or more of the components 208-210 may be implemented in hardware and/or software. In one embodiment, the components 208-210 are implemented as dedicated circuits, such as Application Specific Integrated Circuits (ASICs) where the dedicated circuits are configured to perform predetermined functions. Additionally, and/or alternatively, the components 208-210 may be implemented as software, where the processor(s) 204 are configured to execute computer-readable instructions that implement the components 208-210. Furthermore, combinations of the foregoing are possible, where some components are implemented as dedicated circuits and other modules are implemented in software. In this manner, the computing device 104 may include components 208-210 that are implemented in hardware and/or software.

The communication interface 202 is configured to communicate with the other computing devices 106-114 and/or the cloud computing platform 116, the document management server 118, and/or the e-mail server 120. In this regard, communication with the computing devices 106-114 and/or the cloud computing platform 116, the document management server 118, and/or the e-mail server 120 includes receiving data from, and sending data to, the cloud computing platform 116, the document management server 118, and/or the e-mail server 120 and/or the other computing devices 106-114. Examples of data communicated between the computing device 104 and the cloud computing platform 116, the document management server 118, and/or the e-mail server 120 includes video data, such as a live video stream or a prerecorded video stored at the computing device 104, audio data, such as a call or other audio-only communication session established among the computing devices 106-114, text data, such as text messages communicated among the computing devices 106-114, event notification data, such as alert information alerting a user account at a client device about a particular event, and other such types of information.

The communication interface 202 may include one or more wired and/or wireless communication interfaces. For example, the communication interface 202 may include a wireless transceiver, a Bluetooth® radio, and/or a wired network interface. In one embodiment, the communication interface 202 is configured to establish a wireless communication channel with the computing devices 106-114 and/or the cloud computing platform 116, the document management server 118, and/or the e-mail server 120 using one or more wireless communication protocols such as 802.11 b/g/n. Additionally, and/or alternatively, the computing device 104 may establish a communication channel with the cloud computing platform 116, the document management server 118, and/or the e-mail server 120 and/or the other computing devices 106-114 via a wire or other physical medium (e.g., via an Ethernet cable or the like).

The processor(s) 204 are configured to execute computer-readable instructions that implement one or more of the application(s) 208. Additionally, and/or alternatively, the processor(s) 204 may be configured to retrieve computer-readable instructions from the computer storage device 206. The one or more processor(s) 204 may be any type of commercially available processor, such as processors available from the Intel Corporation, Advanced Micro Devices, Texas Instruments, or other such processors. Further still, the one or more processor(s) 204 may include one or more special-purpose processors, such as a Field-Programmable Gate Array (FPGA) or an Application Specific Integrated Circuit (ASIC). The one or more processor(s) 204 may also include programmable logic or circuitry that is temporarily configured by software to perform certain operations. Thus, once configured by such software, the one or more processor(s) 204 become specific machines (or specific components of a machine) uniquely tailored to perform the configured functions and are no longer general-purpose processor(s) 204.

Where the one or more processor(s) 204 implement the applications 208-216 via one or more computer-readable instructions, the computer-readable instructions may be written in one or more computer-programming and/or computer-scripting languages. Examples of such languages include, but are not limited to, C, C++, C#, Java, JavaScript, Perl, Python, or any other computer programming and/or scripting language now known or later developed.

The computing device 104 may further include various computer storage device(s) 206 and/or computer-readable medium(s) for storing the application(s) 208 and/or the data 210. The computer storage device 206 includes one or more physical devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “computer storage device” should be taken to include a single device or multiple devices (e.g., a centralized or distributed database, or associated caches and servers) able to store the application(s) 208 and the data 210. Accordingly, the computer storage device 206 may be implemented as a single storage apparatus or device, or, alternatively and/or additionally, as “cloud-based” storage systems or storage networks that include multiple storage apparatus or devices.

The application(s) 208 include an operating system 212, a presence monitoring agent 214, a communication client 216, and various productivity applications 218-222, such as a word processing application 218, a spreadsheet application 220, and a presentation application 222.

As one of ordinary skill in the art, the operating system 212 includes system software that manages computer hardware, software resources, and provides common services for computer programs. The operating system 212 may manage and reference one or more user accounts, such as user account 224, that allows a user of the computing device 104 to access one or more of the application(s) 208 and/or the data 210. The user may interact with the operating system 212 using command line tools, graphical user interfaces, or combinations thereof. One example of an operating system 212 is MICROSOFT WINDOWS®, which is also available from the Microsoft Corporation.

A user using the computing device 104 may have one or more user account(s) 224 with the operating system 212. Each of the one or more user account(s) 224 may include information about the user, such as the user's name, contact information (e.g., user identifier, phone number, e-mail address, etc.), date of birth, home directory, user preferences and other such information. The user may have one or more user account(s) 224, where each user account is associated with an application 208 executable by the computing device 104. For example, the user account(s) 224 may include a user account for the operating system 212, a user account for the communication client 216, a user account for one or more of the productivity applications 218-222, and so forth. Additionally, and/or alternatively, a user account may be shared among one or more of the application(s) 208. Thus, and as one example, the operating system 212 and/or the communication client 216 may share a user account.

A user account may be associated with a current status 226 that indicates a status of the user. A graphical user interface provided by the operating system 212 may allow the user to set or establish the current status 226. In one embodiment, the current status 226 is selectable from a plurality of status values, where each status value comprises one or more alphanumeric characters. In another embodiment, the user may be able to provide his or her own status via an input device, such as a keyboard. Examples of status values for the current status 226 include, but are not limited to, “Available,” “Busy,” “Do Not Disturb,” “I am currently unavailable,” and other such values.

The current status 226 may be visible and/or communicated to one or more of the other computing devices 106-114. In one embodiment, the communication client 216 is configured to communicate with other communication clients executable by one or more of the other computing devices 106-114. Each communication client 216 may be configured to provide a current status 226 to another communication client. For example, the communication client of the computing device 104 may provide the current status 226 of a user account 224 to the communication client of the computing device 106. Thus, the user of the computing device 106 may see that the user of the computing device 104 is “Available,” “Busy,” “Do Not Disturb,” and vice versa. It should be understood that the current status 226 may be directly provided to one or more of the computing devices 106-114, but that the current status 226 may also be communicated via an intermediary device, such as the cloud computing platform 116, the document management server 118, and/or the e-mail server 120. For example, when the current status 226 is provided with a value, the current status 226 may be communicated to the cloud computing platform 116, which may then communicate the current status to the other communication clients of the computing devices 106-114.

Under some circumstances, a default value for the current status 226 is applied, such as when the communication client 216 is first instantiated by the computing device 104. Under other circumstances, the user may set the value for the current status 226.

As the user uses the computing device 104, the user may change his or her current status 226 after initially setting it. For example, the user may become busy with a particular project and task, and where the current status 226 has a value of “Available,” the user may change the current status 226 to another value (e.g., the second status 230), such as “Busy” or “Unavailable” to indicate that the user is busy with the particular project or task. Additionally, and as discussed with reference to FIGS. 3-9, the communication client 216 may display a prompt or other graphical interface that queries whether the user would like to change his or her current status 226 to the second status 230. Prompting the user to change his or her status in response to an event is helpful because it reminds the user that the current status 226 may not be the status preferred by the user.

However, one of the challenges in allowing a user to set his or her status, is that the user may forget to change his or her status after the particular project or task is completed or after a particular event has occurred. Accordingly, a presence monitoring agent 214 is configured to monitor the conditions under which the operating system 212 is being used and for which a current status 226 is set. In one embodiment, the presence monitoring agent 214 executes as a background process of the operating system 212. In another embodiment, the presence monitoring agent 214 is executed as a foreground process of the operating system 212. As understood by one of ordinary skill in the art, a background process is a computer process that runs behind the scenes (e.g., in the background) and without user intervention. A background process is distinguishable from a foreground process, which is typically a computer process that the user of the computing device 104 is currently interacting with or provides a user interface for the user to interact with. One or more of the applications 208 may start in the foreground of the operating system 212, such as the communication client 216, the word processing application 218, the spreadsheet application 220, and/or the presentation application 222.

To monitor the conditions of the computing device 104, the presence monitoring agent 214 employs one or more contexts. As used herein, a context may represents a state or condition of an application 216-222 of the computing device 104. The context of an application 216-222 may change as the user interacts with the application 216-222. In one embodiment, the presence monitoring agent 214 stores a first context 228 (e.g., a current context) of the application 216-222. While the first context 228 may represent the state or condition of the application 216-222, one of ordinary skill in the art will appreciate that the first context 228 may also represent the state or condition of other components of the computing device 104, such as the communication client 216, the productivity application(s) 216-222, or any other component of the computing device 104.

While the presence monitoring agent 214 is running in the background of the operating system 212, the presence monitoring agent 214 monitors the context of the application 216-222. As the context changes, the presence monitoring agent 214 updates the stored context to reflect those changes. The presence monitoring agent 214 may store the context in an application 216-222 is being used as the first context 228 and/or the second context 232. As will be discussed below with reference to FIGS. 3-9, the presence monitoring agent 214 uses the first context 228 and the second context 232 to determine whether to revert a current status associated with the second context 232 to a prior status associated with the first context 228.

In addition, not all changes in the context of an application 216-222 may cause a change in the status of the user account. In one embodiment, the applications 216-222 are assigned to either a first group or a second group, where changes in the context of an application assigned to the first group can cause changes to the status of the user account and changes in the context of an application assigned to the second group do not cause changes to the status of the user account. The manner in which the applications 216-222 are assigned to the groups may be defined by the user, such that the user may selectively control whether a change in context of an application can cause a change in the status of a user account.

A context may include a plurality of context attributes, where each context attribute may be associated with a corresponding context attribute value. The presence monitoring agent 214 may be programmed or configured to define those context attributes that comprise the first context 228. Furthermore, the values for those context attributes may change as the user interacts with a particular application 216-222 and/or operates the computing device 104. Examples of context attributes
the name of an application displayed in a focused window of a graphical user interface;
the type of application displayed in a focused window of a graphical user interface;
the display size of a focused window of a graphical user interface;
the amount of time an application has been in displayed in a focused window of a graphical user interface;
the amount of time that has elapsed since the user operated an input device;
whether the user is actively moving a mouse cursor in a graphical user interface; and,
the number of open applications that are not in a focused window of a graphical user interface.

To obtain the context attribute values for the one or more context attributes, the presence monitoring agent 214 may leverage a dynamic link library (“DLL”) provided by the operating system 212. As one of ordinary skill in the art will understand, a DLL is a software library that contains code and data that can be used by more than one program at the same time. The operating system 212 may provide a DLL (or other application programming interface) that the presence monitoring agent 214 can use to request particular context attribute values. For example, the Windows operating system provides a DLL named “user32.d11” that contains Windows API functions related to the graphical user interface of the operating system. The presence monitoring agent 214 may execute one or more functions provided by user32.d11, where the output of such functions includes one or more of the context attribute values listed above.

One or more of the context attributes may further define a state of a particular application 208. For example, the word processing application 218 displayed in as focused window of a graphical user interface may indicate a first state of the word processing application 218. Similarly, a focused window being displayed that indicates the communication client 216 has received a message or event may also indicate a state of the communication client 216. As the user interacts with the various applications 208, the applications 208 may change state, and the state of an application 208 may be determined from one or more of the context attributes. In some instances, a state of an application may be defined by one or more state attributes, and one or more of the state attributes may correspond to one or more of the context attributes.

Using the foregoing context attributes as examples, the user may use the word processing application 218 in a focused window of the graphical user interface for the operating system 212 and then switch to the spreadsheet application 220 to the focused window. Changing the word processing application 218 to the spreadsheet application 220 may cause a change in the context in which the operating system 212 is being used. Accordingly, the use of the word processing application 218 in the focused window may be considered a first context 228, and the switching to the spreadsheet application 220 to be in the focused window may be considered a second context 232. The presence monitoring agent 214 is configured to monitor for these changes and update the context accordingly.

In one embodiment, the presence monitoring agent 214 is programmed or configured to determine that the context has changed or switched when one or more of the context attributes have changed. For example, the presence monitoring agent 214 may be programmed or configured to determine that the context has changed when only one context attribute has changed, such as the name of the application displayed in the focused window of the graphical user interface. As another example, the presence monitoring agent 214 may be programmed or configured to determine that the context has changed when a combination of context attributes have changed, such as the display size of the focused window and the type of application being displayed in the focused window.

In one embodiment, the presence monitoring agent 214 is programmed with one or more rules that determine whether a context has changed based on the changes in the context attributes. The one or more rules may be programmed or preset by an administrator of the operating system 212, or the presence monitoring agent 214 may provide a user interface that allows a user to modify the one or more rules. Further still, the presence monitoring agent 214 may use one or more machine-learning algorithms, such as a regression model, a support vector machine, a naive Bayes classifier, a deep neural network, a recurrent neural network, or any other machine-learning algorithm now known or later developed. The training data for the machine-learning algorithm may include different contexts associated with their corresponding context attribute values. The output for the machine-learning algorithm may be a machine-learning model that accepts as input one or more of the context attribute values, and returns a context likely to be associated with the input of the one or more context attribute values.

Further training for the machine-learning model may include using a set of labeled data that associates a change in a status of the user with a change in context. Alternatively, the machine-learning model may be trained through observation and monitoring of the user of the operating system 212, such as when the user changes his or her current status 226 and there is a corresponding change in context. This training data may be used by the machine-learning algorithm to develop a machine-learning model that suggests a particular status in response to a change in context.

When the presence monitoring agent 214 determines that the context has changed, the presence monitoring agent 214 may then determine whether the application with the change in context is assigned to a predefined group of applications that can cause a change in the status of the user account. Should the application with the changed context not belong to the predefined group of applications, the presence monitoring agent 214 may determine not to take a particular action with respect to the application.

However, where the presence monitoring agent 214 determines that the application with the change in context is assigned to the predefined group of applications, the presence monitoring agent 214 may then store the changed context as the second context 232. Should the second context 232 change, the presence monitoring agent 214 may then store that new context as the first context 228. In this manner, the presence monitoring agent 214 may alternate between the first context 228 and the second context 232 for storing the current context based on whether the application with the change in contest is assigned to the predefined group of applications. As discussed below, the presence monitoring agent 214 may store the second context 232 separately from the first context 228 so that the presence monitoring agent 214 can revert the status of the user account back to the status associated with the first context 228.

The communication client 216 is configured to communicate with other communication clients of the other computing devices 106-114. The communication client 216 may communicate using audio, video, text, or combinations thereof. The communication client 216 may also display the current status 226 associated with a user account 224. In one embodiment, the communication client 216 integrates with one or more of the application(s) 208, such as the word processing application 218, the spreadsheet application 220, and/or the presentation application 222, such that information received by the communication client 216 may be presented within one or more of these application(s) 208. By integrating with one or more of the application(s) 208, the user of the computing device 104 may interact with the communication client 216 without having to change the focus of the focused window (e.g., the word processing application 218 is displayed within the focused window).

The communication client 216 is configured to receive events (or notifications) from one or more of the devices 106-120. The communication client 216 may receive the events or notifications from the computing devices 106-114 or from the cloud computing platform 116, the document management server 118, and/or the e-mail server 120. In this regard, an event or notification is a message that contains information about a particular topic or subject. For example, the event or notification may be message from another user of one of the computing devices (e.g., sent by the user of the computing device 106) that includes a text message (e.g., “Are you busy?”). As another example, the event or notification may be a reminder about a topic, such as an upcoming meeting, a calendar appointment, or a task to be completed.

The communication client 216 may be configured to display the event or notification to the user via a prompt or other graphical element. In one embodiment, the prompt is overlaid the focused window that currently has the user's focus. In another embodiment, the prompt is displayed within the focused window and at a predetermined location. In addition, the communication client 216 may present a plurality of options for responding to the event or notification. The prompt options displayable to the user may be stored as prompt options 234. The prompt options 234 may include preprogrammed and/or default options that were provided by the developer of the communication client 216, custom prompt options that were entered in by the user (e.g., from a prior session with the communication client 216), or a combination thereof. In one embodiment, the user may access one or more menu options of the communication client 216 to add, remove, and/or modify the prompt options 234 that are displayable to the user in response to a received event and/or notification.

The communication client 216 may also display the prompt based on changes in the context of an application that has been assigned to the predefined group of applications that can cause a change in the status of the user account. In one embodiment, the communication client 216 determines whether the application with the change in context belongs to the predefined group of applications. Where the communication client 216 makes this determination in the affirmative, the communication client 216 may cause the display of the prompt. Where the communication client 216 makes this determination in the negative, the communication client 216 may not cause the display of the prompt. To facilitate this determination, the data 210 may include a logical construct, such as a two-dimensional table or the like, that identifies and/or associates whether an application 216-222 is assigned to the predefined group of applications. In this fashion, changes in the context of a particular application may cause the communication client 216 to display the prompt. Thus, there may be instances where an event or notification has not been received, but a change in the context of a particular application causes the communication client 216 to display the prompt.

In one embodiment, the plurality of options includes an option for the user to change the current status 226 of the user account 224. The presence monitoring agent 214 may be programmed or configured to monitor for received events and/or notifications and, where an event or notification is received, to determine whether the user has changed the current status 226. Where a change in the current status 226 occurs in response to a received event or notification, the presence monitoring agent 214 stores the context during which the event or notification was received (e.g., storing the context as the first context 228). Storing the context may include storing one or more of the context attribute values as the first context 228 and/or the second context 232.

In one embodiment, the communication client 216 selects which of the prompt options 234 to display based on the stored context (e.g., the first context 228), the type of notification or event that the communication client 216 received, or a combination of the two. The communication client 216 may include a rule set, a matrix, a two-dimensional table, a set of conditional or branching statements, or other logical statements that output which of the prompt options 234 that communication client 216 should select and display as prompt options.

When the user the selects a prompt option from the plurality of prompt options 234, the current status 226 may be replaced with a status corresponding to the selected prompt option. Additionally, and/or alternatively, the selected prompt option may include accepting a custom status from the user. The custom status or the selected prompt option may then replace the current status 226. Prior to its replacement, the communication client 216 may store the current status 226 as the second status 230.

As the presence monitoring agent 214 may be running as a background process of the operating system 212, the presence monitoring agent 214 may monitor the actions of the user relative to the first context 228. Where the current status 226 is replaced with another status, the presence monitoring agent 214 logs that the current status 226 was replaced and that the first context 228 should be stored as the second context 232. In this manner, the second context 232 and the second status 230 correspond to the context and status existing at the time the communication client 216 received the event and/or notification.

In some instances, the presence monitoring agent 214 may change the status of the user account without instructing the communication client 216 to display a prompt. In one embodiment, the presence monitoring agent 214 is configured or programmed to change the status of the user account based in a change in context of application assigned to the predefined group of applications that can cause a change in the user account based on a change in context. The presence monitoring agent 214 may reference a logical construct (e.g., a two-dimensional table, array, conditional statements, etc.) that associates contexts with corresponding user account status value. Thus, when an application, assigned to the predefined group of applications, changes context, the presence monitoring agent 214 references the logical construct to determine which user account status value should be assigned to the user account status (e.g., the current status 226).

At some point, the user may change the context of the application. While the user is working on his or her task (e.g., the time after which the current status 226 was changed), the presence monitoring agent 214 is monitoring the actions of the user to determine whether the context has changed since changing the current status 226. If the presence monitoring agent 214 determines that the context has changed (e.g., that the first context 228 has changed), the presence monitoring agent 214 then determines whether the current status 226 should be reverted to the status at the time the communication client 216 received the event or notification (e.g., whether the current status 226 should be changed to the value of the second status 230).

In one embodiment, the presence monitoring agent 214 determines whether the context has changed by comparing one or more of the context attribute values of the first context 228 (e.g., the current context) with one or more context attribute values of the second context 232 (e.g., the context existing at the time the event or notification was received or the context existing at the time the user changed the current status 226). As discussed above, the presence monitoring agent 214 may determine that the context has changed when only one context attribute has changed; in other instances, the presence monitoring agent 214 determines that the context has changed when more than one context attribute has changed. The presence monitoring agent 214 may be configured or programmed to compare one or more context attributes of the first context 228 with one or more context attributes of the second context 232.

Where the presence monitoring agent 214 determines that the context has not changed, the presence monitoring agent 214 continues monitoring the actions of the user. However, where the presence monitoring agent 214 determines that the context has changed, the presence monitoring agent 214 may then determine whether the change in context should result in reverting the current status 226 to the second status 230 (e.g., the status that was saved at the time the communication client 216 received the event or notification). In one embodiment, the presence monitoring agent 214 is configured to replace the current status 226 with the second status 230, where the context has changed based on changes in particular context attributes.

In addition, the presence monitoring agent 214 may be configured or programmed to modulate the current status 226 in accordance with changes in context. For example, where the presence monitoring agent 214 reverts the current status 226 to the second status 230, the presence monitoring agent 214 may then store the current status 226 as the second status 230. Thus, the current status 226 is saved to the second status 230, while the value of the second status 230 then becomes the current status 226 (e.g., the current status 226 becomes the status of the user account prior to the receipt of the event or notification). In other words, the presence monitoring agent 214 swaps the values of the current status 226 and the second status 230. As example, the current status 226 may be “Currently Busy: Please try again later” and the second status 230 may be “I'm available today.” The swapping of the values would result in the current status 226 being “I'm available today” and the second status 230 being “Currently Busy: Please try again later.”

Saving the current status 226 (e.g., the status of the user account after the user changed the status in response to the event or notification) allows the presence monitoring agent 214 to revert the current status 226 back to the second status 230 should the presence monitoring agent 214 determine that one or more of the context attribute values of the first context 228 equal one or more of the context attribute values of the second context 232.

As one example, suppose that the presence monitoring agent 214 is comparing the application name displayed in the focused window of the operating system 212 of the second context 232 with the application name displayed in the focused window of the first context 228. In the second context 232, the application name may be “Word Processing Application” and in the first context, the application name may be “Spreadsheet Application.” One of ordinary skill in the art will appreciate that the terms “Word Processing Application” and “Spreadsheet Application” (and other such generic names) may be replaced with specific names of software applications. The name of the focused window may also include other types of titles, such as a filename path, a document name, or any other type of name displayable in the focused window.

The presence monitoring agent 214 may determine that the foregoing change in the application name is a change in context. However, the presence monitoring agent 214 may be programmed with a rule or condition that states that a change in context based on the application name in the focused window does not result in the reversion of the current status 236. In another implementation, a change in the application name of the focused window from “Word Processing Application” to “Spreadsheet Application” may not result in a change in context. In this implementation, the presence monitoring agent 214 does not act on the current status 226 and continues monitoring for a change in context.

As another example, and using the application name of the focused window in this example, suppose that the application name changes from “Word Processing Application” to “Video Game” or “Web Browser.” The presence monitoring agent 214 may be configured or programmed to determine that this is a change in context and, further still, that such change should result in the replacement of the current status 226 with the status stored as the second status 230. Similarly, the second status 230 is replaced with the value of the current status 226. Thus, the current status 226 at the time the application in the focused window is “Video Game” or “Web Browser” becomes the status of the user account prior to the receipt of the event or notification that caused the initial change in the user account status. In addition, where the application name of the focused window changes back from “Video Game” or “Web Browser” to “Word Processing Application,” the presence monitoring agent 214 determines that the first context 228 is equal to the second context 232 (e.g., by comparing the application name context attributes), and thus, changes the current status 226 to the status stored in the second status 230. In this manner, the presence monitoring agent 214 (or the communication client 216 via an instruction from the presence monitoring agent 214) may change or replace the current status 226 with the status stored in the second status 230 and vice versa.

Automatically changing or reverting a status to a prior status is beneficial to the user for several reasons. First, a user may forget that he or she changed the current status 226 when the communication client 216 displayed the received event or notification. As a person may have multiple tasks to focus on, not having to remember to change his or her status is one less task to be concerned with. Second, the user may want other users (e.g., users of the computing devices 106-114) to know that he or she completed a particular task or project. By automatically reverting the status based on a change in context, other users are made contemporaneously aware that the user has completed his or her task or project. Third, automatically changing the status is one less item that requires the user's attention. As a user may have multiple tasks or projects to focus on, automatically changing the status based on the change in context results in the user not having to divert his or her attention away from other tasks or jobs. Furthermore, as a user may switch tasks or applications frequently, the presence monitoring agent 214 also similarly changes his or her user account status; thus, the user does not have to constantly change his or her user account status based on whether he or she is working on other tasks or projects. Thus, this disclosure provides several benefits to the user as he or she works within the operating system 212 and the various application(s) it provides 208.

FIGS. 3-8 illustrate a user changing the current status 226 in accordance with an example embodiment. FIG. 3 illustrates a graphical user interface 302 showing a current status 304 of a user account, in accordance with an example embodiment. In one embodiment, the current status 304 is a graphical representation of the value stored by the current status 226. In the embodiment shown in FIG. 3, the current status 304 is a graphic of a checkmark overlaid an image of the user. This checkmark signals to other users (e.g., users of the computing devices 106-114) that the user of the computing device 104 is available. The graphical user interface 302 may be an interface to the communication client 216 and considered the focused window. As shown in FIG. 3, the user has selected an electronic document 306 to view and/or edit.

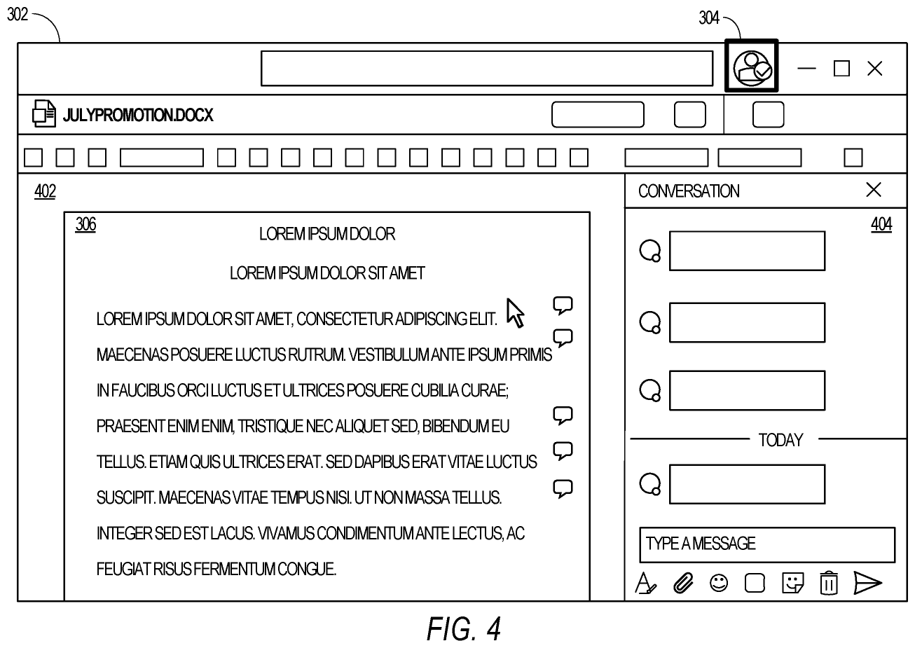

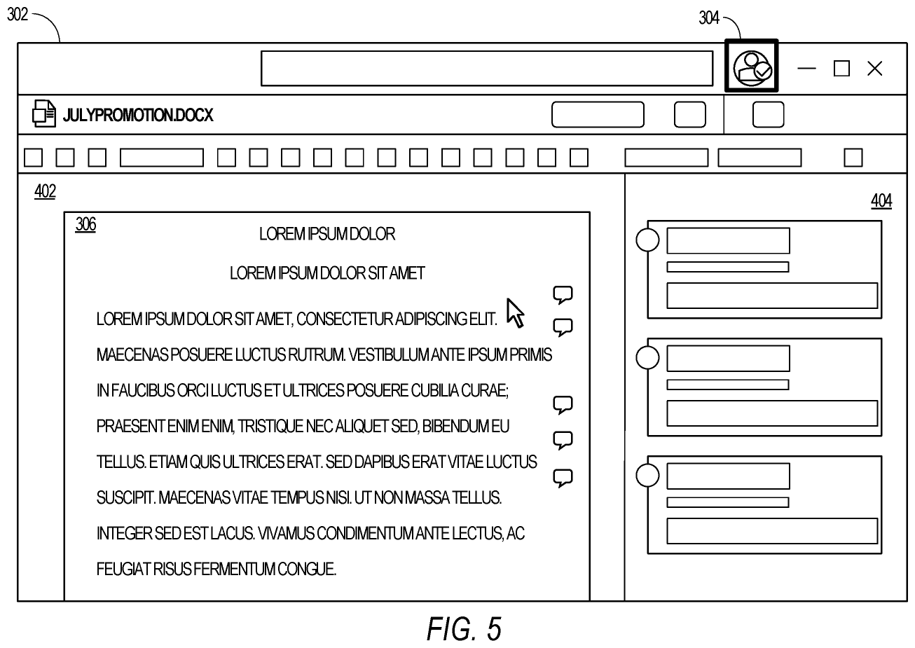

FIG. 4 illustrates the graphical user interface 302 with an electronic document displayed in a primary window section 402, in accordance with an example embodiment. The graphical user interface 302 also includes a secondary window section 404, where additional information may be displayed. In one embodiment, the user may choose the type of information to display in the second window section 404. In FIG. 4, the user has chosen to display a text-based conversation from where the electronic document 306 was obtained. In later Figures, such as FIGS. 5-8, the second window section 404 displays edits made to, and/or comments about, the electronic document 306. The user may work on the electronic document 306 in the primary window section 402.

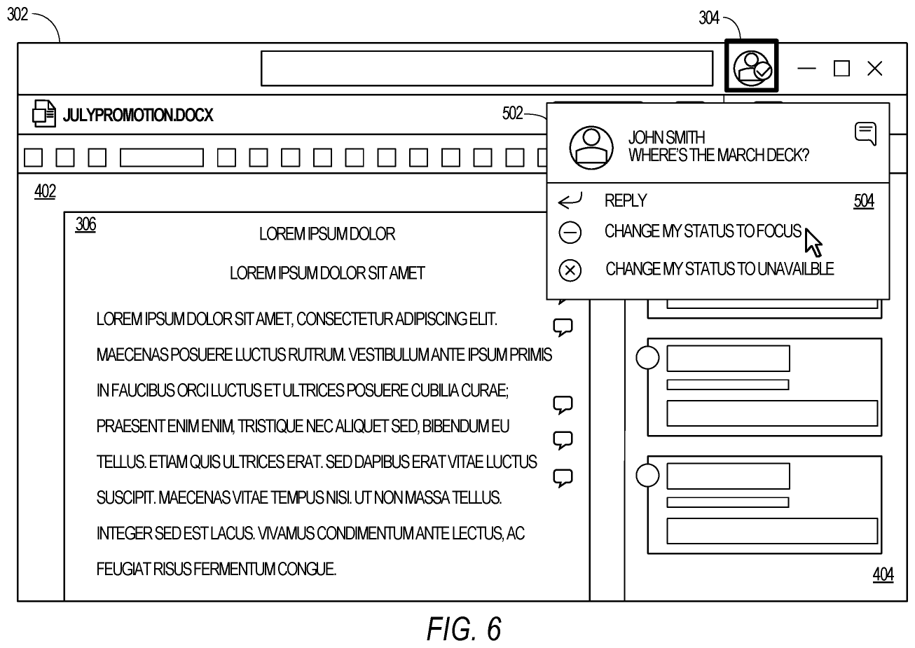

Referring next to FIG. 5, FIG. 5 illustrates the graphical user interface 302, in accordance with an example embodiment, where the secondary window section 404 includes a list of revisions, comments, and/or edits that have been made to the electronic document 306. In FIG. 5, the user may be actively working on the electronic document 306 as displayed in the graphical user interface 302. Next, FIG. 6 illustrates the graphical user interface 302, in accordance with an example embodiment, where the communication client 216 has received an event or notification from another user. In FIG. 6, the graphical user interface 302 displays a prompt 502 having one or more prompt options 504 that the user may select for responding to the event or notification. As discussed above, the prompt options 504 that are displayed via the graphical user interface 302 may be retrieved from the prompt options 234. As shown in FIG. 6, the prompt options 504 include a first prompt option to change the current status 226 to “Focus” and a second prompt option to change the current status 226 to “Unavailable.” Each of the prompt options 504 are associated with a graphic that indicates the status of the user.

In one embodiment, the communication client 216 selects which of the prompt options 504 to display based on the context of the user account (e.g., the first context 228), the type of notification or event that the communication client 216 received, or a combination of the two. As explained with reference to FIG. 2, the communication client 216 may include a rule set, a matrix, a two-dimensional table, a set of conditional or branching statements, or other logical statements that output which of the prompt options 234 that communication client 216 should select and then display as the prompt options 504. As one example, and with reference to FIG. 6, the message-type event notification and the current context of working on a word processing document, has resulted in the communication client 216 selecting and displaying the two prompt options 504.

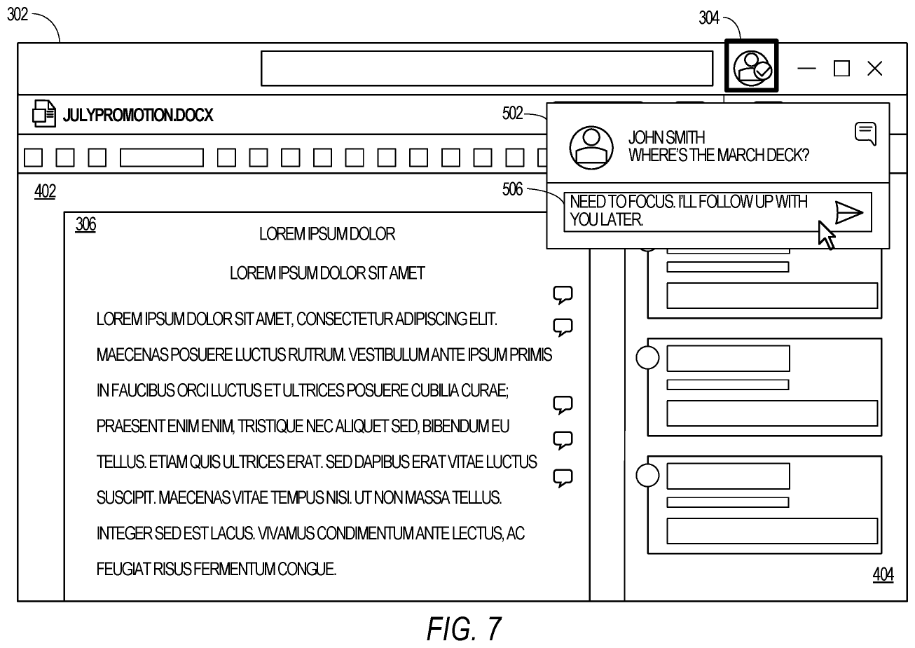

FIG. 7 illustrates the graphical user interface 302, where the user has selected the first prompt option of the prompt options 504 to respond to the prompt 502. The status associated with the first prompt option, “Focus,” will become the current status 226 of the user account. However, in addition, the communication client 216 also allows the user to provide a message that will be associated with the selected status. In one embodiment, the communication client 216 displays a text element 506 that allows the user to provide (e.g., type, speak, etc.) a message to be associated with the selected status. In some instances, the message may be displayed in response to other messages received from other communication clients.

To store the selected status, the communication client 216 may store the initial status (e.g., the current status 226) as the second status 230, and then store the selected status and entered message as the current status 226. In addition, the presence monitoring agent 214 may log and/or store the context attribute values that define the context in which the user is working as the second context 232. The presence monitoring agent 214 then monitors the context of the application and stores the context attribute values as the first context 228 (e.g., the current context).

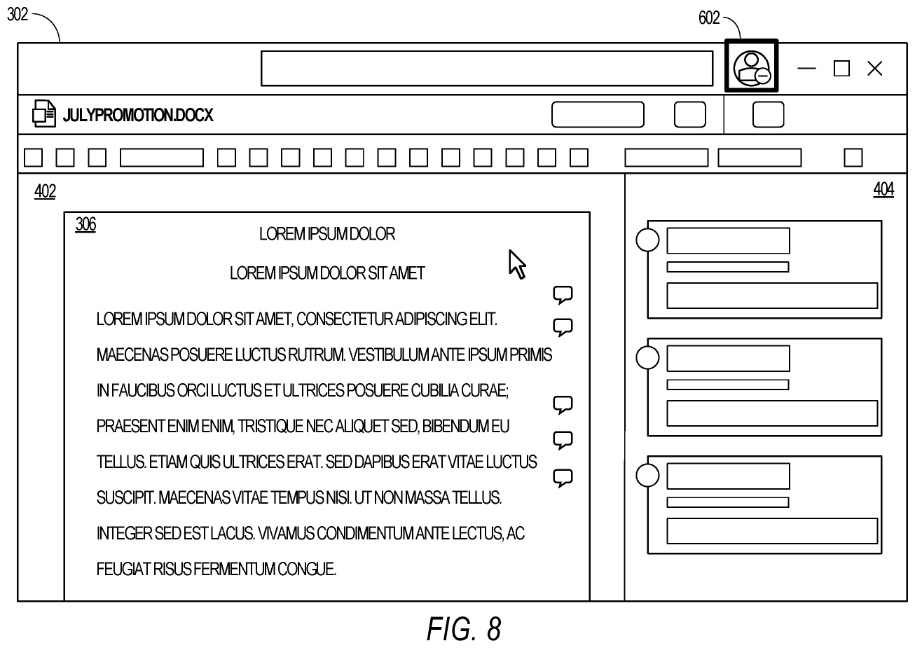

FIG. 8 illustrates the graphical user interface 302 where the custom status 602 (e.g., the current status 226) is now established for the user account. As discussed with reference to FIG. 6, each of the prompt options 504 were associated with a graphical representation. In FIG. 8, the graphical representation associated with the prompt option 504 is displayed overlaid or with a graphic representing the user account. The graphical representation confirms to the user that the user account is associated with the desired status.

As explained above, the selected status 602 may remain in place for the user account until the user switches or changes the context in which he or she is using the operating system 212. When the user switches contexts (e.g., the presence monitoring agent 214 determines that the first context 228 is different from the second context 232), the presence monitoring agent 214 and/or the communication client 216 may change the current status 226 back to the second status 230 (e.g., overwrite the value of the current status 226 with the value of the second status 230). Thus, the current status 226 remains in place after the user responds to the event or notification, but reverts back to the status prior to the receipt of the event or notification based on a change in context of a predefined application (e.g., a change in one or more of the context attribute values of the first context 228).

While FIGS. 3-8 illustrate a change in the current status 226 in response to a received an event or notification, there may be instances where the current status 226 may change based on a change in context. As discussed above, the presence monitoring agent 214 may be configured with a machine-learning algorithm that develops a machine-learning model that associates statuses with changes in context. Accordingly, when the presence monitoring agent 214 detects a change in context, the presence monitoring agent 214 may use the change in context as an input signal to the machine-learning model, which may then output one or more suggested statuses for display to the user. The suggested statuses may be stored as prompt options 234, which may then be displayed as a prompt for the user to select (e.g., similar to the prompt 502 illustrated in FIG. 6). The presence monitoring agent 214 may then issue an instruction to the communication client 216 to display the prompt options 234.

In another embodiment, the presence monitoring agent 214 may instruct the communication client 216 to automatically change the current status 226 of the user account to a suggested status. For example, the presence monitoring agent 214 may present a query or other prompt to the user requesting authorization to automatically change the status in response to changes in context. Where the user provides authorization to the presence monitoring agent 214, the presence monitoring agent 214 may then automatically change the status of the user account—either on its own or via the communication client 216. Further still, the presence monitoring agent 214 may periodically query the user for feedback as to the quality of the changed status (e.g., to provide a rating of the changed status), and may then use this signal as input to the machine-learning model to further improve the selection of the status to change to the current status 236.

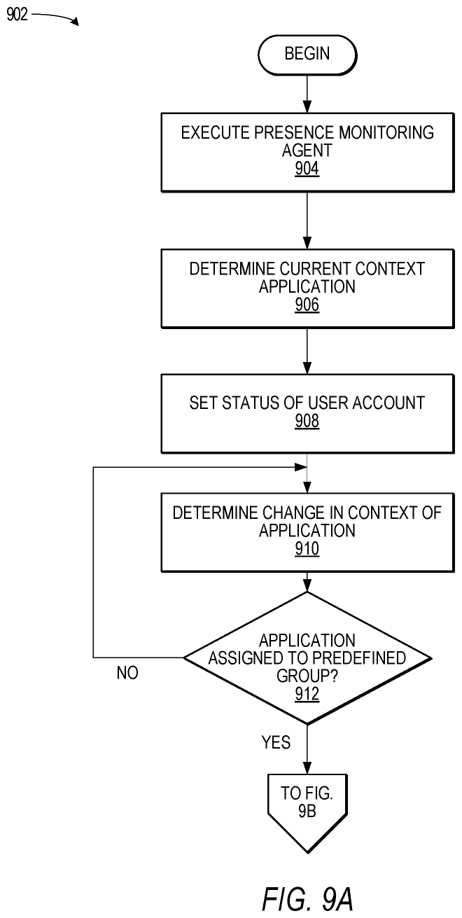

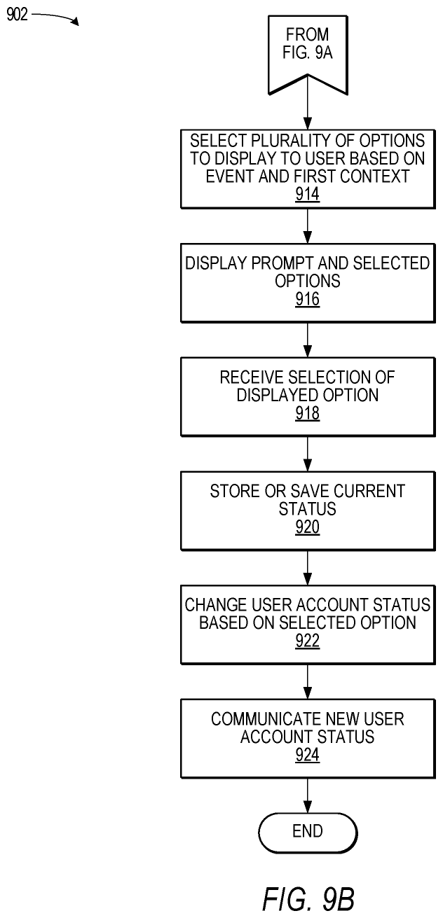

FIGS. 9A-9B illustrate a method 902, in accordance with an example embodiment, for changing the status of a user account in response to a received event or notification. The method 902 may be implemented by one or more of the components illustrated in FIG. 2 and is discussed by way of reference thereto.

Referring initially to FIG. 9A, the computing device 104 executes the presence monitoring agent 214 which monitors for changes in the context of an application (Operation 904). As explained above, the presence monitoring agent 214 may execute as a background process of the operating system 212 and leverage one or more functions provided by a DLL to determine whether the context of an application (e.g., applications 216-222) has changed.

The presence monitoring agent 214 then determines the current context of an application being used by the user (Operation 906). In one embodiment, the presence monitoring agent populates one or more context attributes with corresponding context attribute values, and stores the context attribute values as the first context 228. As explained with reference to FIGS. 3-8, the first context 228 may represent the current context of the application, but may be later stored as the second context 232 in response to a change in the current status 226.

At Operation 908, the current status 226 of the user account is set. In one embodiment, the communication client 216 is configured to apply a default status as the user account status when the communication client 216 is executed. In another embodiment, the user manually enters or selects a status as the current status 226 via a graphical user interface of the communication client 216. In yet a third embodiment, the communication client 216 establishes the current status 226 based on the first context 228, such as by referencing a two-dimensional table or the like using one or more context attribute values of the first context 228, and then selecting a status from the two-dimensional table based on the one or more context attribute values. Combinations of the foregoing embodiments are also possible.

At some later time, the presence monitoring agent 214 determines that there is a change in context of an application (Operation 910), such as when the user moves the application to another display of the computing device 104, minimizes the application, changes the application displayed in a focused window of a graphical user interface, and so forth.

The presence monitoring agent 214 then determines whether the application with the change in context is an application from a predefined group of applications, where the predefined group of applications includes those applications where the change in context of an application causes a change in the user account status (Operation 912). As discussed above, the computer storage device 206 may store a logical construct that associates one or more of the application(s) 208 with the predefined group of applications, and the presence monitoring agent 214 determines whether the application with the change in context is assigned to the predefined group. Where the presence monitoring agent 214 makes this determination in the negative (e.g., the “NO” branch of Operation 912), the method 902 returns to Operation 912 where the presence monitoring agent 214 continues to monitor for changes in contexts of application(s) 208. This determination may further cause the communication client 216 not to display a prompt or other notification to change the user account status.

In contrast, where the presence monitoring agent 214 makes this determination in the affirmative (e.g., the “YES” branch of Operation 912), the method 902 proceeds to Operation 914 on FIG. 9B. Referring to FIG. 9B, the communication client 216 references the prompt options 234 to determine which of the prompt options 234 to display to the user based on the received event or notification. In one embodiment, an event or notification type is associated with one or more prompt options 234. For example, a messaging event may be associated with a first set of prompt options 234, a calendaring event may be associated with a second set of prompt options 234, a reminder notification may be associated with a third set of prompt options 234, and so forth. Furthermore, the prompt options 234 may not be mutually exclusive such that the prompt options 234 for one type of event or notification may also be associated with a second type of event or notification. The event or notification and its corresponding prompt options 234 may be associated using a logical data structure, such as an array, two-dimensional table, matrix, vector, or any other logical data structure now known or later developed. Accordingly, the communication client 216 may use the received event or notification to determine which of the prompt options 234 to select. In yet a further embodiment, the communication client 216 also uses one or more of the context attribute values to select one or more of the prompt options 234. Thus, the selection of the prompt options 234 may be based on the received event or notification, one or more context attribute values, or both.

The communication client 216 then displays the selected prompt options 234 to the user via a graphical user interface (Operation 916). As shown in FIG. 6, the selected prompt options 234 may be displayed via a prompt 502 (as prompt options 504) overlaid the graphical user interface 302 or within a portion of the graphical user interface 302. The communication client 216 then receives a selection of a prompt option 234 from the user (Operation 918). In one embodiment, the selected prompt option instructs the communication client 216 to establish a particular status for the user account. In another embodiment, the user provides a custom status (e.g., via the text element 506 or the like).

The communication client 216 next stores the current status 226 as the second status 230 (Operation 920). As explained above, the current status 226 is saved as the second status 230 so that the presence monitoring agent 214 and/or the communication client 216 can revert the current status to the value of the second status 230 in response to a change in context of an application. The communication client 216 then changes the current status 226 to the status provided by the user via the prompt 502 (Operation 922). The changed status 226 may then be communicated to one or more of the other devices in communication with the computing device 104, such as the other computing devices 106-114, the cloud computing platform 116, the document management server 118, and/or the e-mail server 120 (Operation 924).

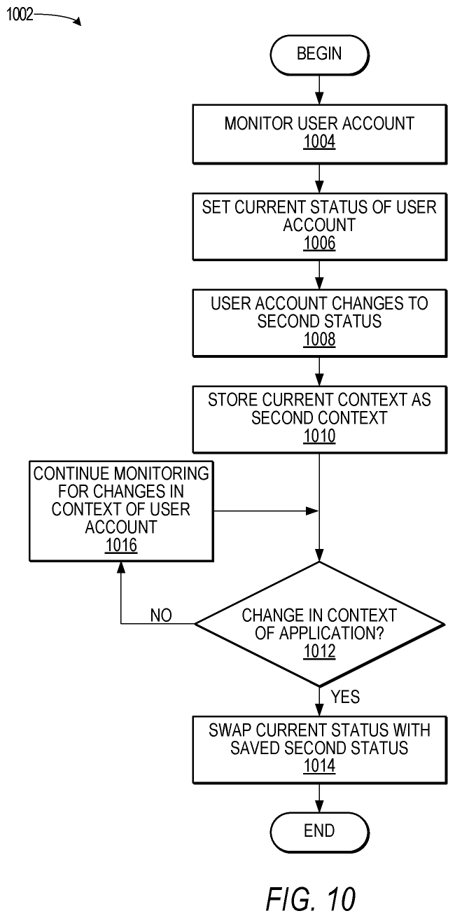

FIG. 10 illustrates a method 1002, in accordance with an example embodiment, for determining whether to change a current status based on a change in context of an application. The method 1002 may be implemented by one or more of the components illustrated in FIG. 2 and is discussed by way of reference thereto.

The method 1002 includes one or more operations that may be executed in conjunction with one or more operations of the method 902. Thus, one or more of the operations shown in FIG. 9 have been omitted from FIG. 10 for clarity and readability.

At Operation 1004, the presence monitoring agent 214 monitors the user account (Operation 1004). The user or the communication client 216 then sets the current status 226 for the user account 224 (Operation 1006). At some later time, the current status 226 for the user account 224 is changed (Operation 1008). As discussed previously, the user may change the current status 226 in response to an event or other notification received by the communication client 216. However, in some instances, the communication client 216 may be configured or programmed to automatically change the current status 226 based on the received event or notification. In yet other instances, the communication client 216 may change the current status 226 based on a change in context of an application belonging to a predefined group of applications.

In response to a change in the current status 226, the presence monitoring agent 214 stores the first context 228 (e.g., the current context) as the second context 232 (Operation 1010). As explained previously, the current context is stored as the second context 232 so that the presence monitoring agent 214 can compare the current context with the second context 232 and determine whether there has been a change in the context since the current status 226 was changed. When the user interacts with an application, one or more of the context attribute values may change (e.g., the application type displayed in the focused window), but these changes may not result in a determination that the context has changed.

At Operation 1012, the presence monitoring agent 214 determines whether there has been a change in context of an application. In one embodiment, the presence monitoring agent 214 determines whether the change in context is for the same application that caused the user account status to change at Operation 1008. In another embodiment, the presence monitoring agent 214 determines whether the change in context is for an application assigned to a predefined group of applications that can cause a change in the user account status. One of ordinary skill in the art will appreciate that such determination may be implemented through event triggers, polling, or other similar technique. As explained previously, the user may alternate or switch between applications as the focused window, and these changes may cause the presence monitoring agent 214 to determine that there has been a change in context. Where the presence monitoring agent 214 determines that there has not been a change in context (e.g., the “NO” branch of Operation 1012), the presence monitoring agent 214 continues monitoring for changes in the context of the application (Operation 1014). However, where the presence monitoring agent 214 determines that there has been a change in context (e.g., the “YES” branch of Operation 1012), the presence monitoring agent 214, or the communication client 216 via an instruction from the presence monitoring agent 214, changes the current status 226 to the value of the second status 230 and also changes the value of the second status 230 to the value of the current status 226 (Operation 1014). Swapping the user account status values allows the presence monitoring agent 214 to then later switch the current status 226 back to the value of the second status 230 should the context also revert back.

In this manner, this disclosure provides for a presence monitoring agent 214 and communication client 216 that monitors the context of an operating system 212 and changes the status of a user account accordingly. As the presence monitoring agent 214 may perform the change in the user account status automatically, the user does not need to manipulate his or her current status 226 when there is a change in context of the application. This feature improves the usability and efficiency of the computing device 104 because it means that there are fewer tasks or jobs for the user to perform as he or she is working on various applications 208 within the operating system 212.

### Modules, Components, and Logic

Certain embodiments are described herein as including logic or a number of components, modules, or mechanisms. Modules may constitute either software modules (e.g., code embodied on a machine-readable medium or machine-readable storage device) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-10 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

FIG. 11 is a block diagram illustrating components of a machine 1100, according to some example embodiments, able to read instructions from a machine-readable medium (e.g., a machine-readable storage medium or machine-readable storage device) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the methods illustrated in FIGS. 9A-10. Additionally, or alternatively, the instructions 1116 may implement one or more of the components of FIGS. 1-2. The machine 1100 may be an implementation of one or more of the devices illustrated in FIG. 1 including, but not limited to, the computing devices 104-114, the document management server 118, or the e-mail server 120.

The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a PDA, or any machine capable of executing the instructions 1116, sequentially or otherwise, that specify actions to be taken by machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory/storage 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 1112 and processor 1114 that may execute the instructions 1116. The term “processor” is intended to include multi-core processor that may comprise two or more independent processors (sometimes referred to as “cores”) that may execute instructions 1116 contemporaneously. Although FIG. 9 shows multiple processors 1110, the machine 1100 may include a single processor with a single core, a single processor with multiple cores (e.g., a multi-core process), multiple processors with a single core, multiple processors with multiples cores, or any combination thereof.

The memory/storage 1130 may include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 may also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of processors 1110 are examples of machine-readable media.

As used herein, “machine-readable medium” includes a machine-readable storage device able to store instructions 1116 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162 among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172, respectively. For example, the communication components 1164 may include a network interface component or other suitable device to interface with the network 1180. In further examples, communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 1180 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A method for presenting contextually-aware response actions, the method comprising:
detecting a first change in a first context of a first application assigned to a plurality of predefined applications, wherein a change in context of an application selected from the plurality of predefined applications causes a display of a prompt;
causing the display of the prompt based on the detected change in the first context of the first application, wherein:
the prompt presents one or more prompt options to a user to change a status of a user account associated with the user from a first status value to a second status value; and
the status indicates an availability of the user;
changing the status of the user account, based on an interaction with the displayed prompt, from the first status value to the second status value;
detecting a second change in a second context of the first application;
changing the status value of the user account from the second status value to the first status value based on the detected second change; and
causing a display of the changed status of the user account in another computing device currently displaying the status of the user account.

2. The method of claim 1, further comprising:
detecting a change in context of a second application that is not assigned to the plurality of predefined applications; and
determining, response to the detected change in context of the second application, not to cause a display of the prompt based on the second application not being assigned to the plurality of predefined applications.

3. The method of claim 2, further comprising:
determining, in response to the detected change in context of the second application, not to change the status of the user account based on the second application not being assigned to the plurality of predefined applications.

4. The method of claim 2, wherein detecting the first change in the first context of the first application comprises:
determining that a graphical user interface in which the first application is displayed was moved from a first display to a second display.

5. The method of claim 2, wherein detecting the first change in the first context of the first application comprises:
determining a change in state of the first application.

6. The method of claim 2, further comprising:
automatically changing the status of the user account from the first status value to the second status value based on the first context; and
automatically changing the status of the user account from the second status value to the first statue value based on the second context.

7. The method of claim 2, wherein the one or more prompt options are selected from a plurality of prompt options based on the detected change in the first context of the first application.

8. A system for presenting contextually-aware response actions, the system comprising:
a computer storage device storing computer-executable instructions; and
one or more processors that, having executed the computer-executable instructions, configure a system to perform a plurality of operations comprising:
detecting a first change in a first context of a first application assigned to a plurality of predefined applications, wherein a change in context of an application selected from the plurality of predefined applications causes a display of a prompt;
causing the display of the prompt based on the detected change in the first context of the first application, wherein:
the prompt presents one or more prompt options to a user to change a status of a user account associated with the user from a first status value to a second status value; and
the status indicates an availability of the user;
changing the status of the user account, based on an interaction with the displayed prompt, from the first status value to the second status value;
detecting a second change in a second context of the first application;
changing the status value of the user account from the second status value to the first status value based on the detected second change; and
causing a display of the changed status of the user account in another computing device currently displaying the status of the user account.

9. The system of claim 8, wherein the plurality of operations further comprises:
detecting a change in context of a second application that is not assigned to the plurality of predefined applications; and
determining, response to the detected change in context of the second application, not to cause a display of the prompt based on the second application not being assigned to the plurality of predefined applications.

10. The system of claim 9, wherein the plurality of operations further comprises:
determining, in response to the detected change in context of the second application, not to change the status of the user account based on the second application not being assigned to the plurality of predefined applications.

11. The system of claim 9, wherein detecting the first change in the first context of the first application comprises:
determining that a graphical user interface in which the first application is displayed was moved from a first display to a second display.

12. The system of claim 9, wherein detecting the first change in the first context of the first application comprises:
determining a change in state of the first application.

13. The system of claim 9, wherein the plurality of operations further comprises:
automatically changing the status of the user account from the first status value to the second status value based on the first context; and
automatically changing the status of the user account from the second status value to the first statue value based on the second context.

14. The system of claim 9, wherein the one or more prompt options are selected from a plurality of prompt options based on the detected change in the first context of the first application.

15. A system for presenting contextually-aware response actions, the system comprising:
means for detecting a first change in a first context of a first application assigned to a plurality of predefined applications, wherein a change in context of an application selected from the plurality of predefined applications causes a display of a prompt;
means for causing the display of the prompt based on the detected change in the first context of the first application, wherein:
the prompt presents one or more prompt options to a user to change a status of a user account associated with the user from a first status value to a second status value; and
the status indicates an availability of the user;
means for changing the status of the user account, based on an interaction with the displayed prompt, from the first status value to the second status value;
means for detecting a second change in a second context of the first application;
means for changing the status value of the user account from the second status value to the first status value based on the detected second change; and
means for causing a display of the changed status of the user account in another computing device currently displaying the status of the user account.

16. The system of claim 15, wherein the system further comprises:
means for detecting a change in context of a second application that is not assigned to the plurality of predefined applications; and
means for determining, in response to the detected change in context of the second application, not to cause a display of the prompt based on the second application not being assigned to the plurality of predefined applications.

17. The system of claim 16, wherein the system further comprises:
means for determining, in response to the detected change in context of the second application, not to change the status of the user account based on the second application not being assigned to the plurality of predefined applications.

18. The system of claim 16, wherein the means for detecting the first change in the first context of the first application detect the first change by:
determining that a graphical user interface in which the first application is displayed was moved from a first display to a second display.

19. The system of claim 16, wherein the means for detecting the first change in the first context of the first application detect the first change by:
determining a change in state of the first application.

20. The system of claim 16, wherein the system further comprises:
automatically changing the status of the user account from the first status value to the second status value based on the first context; and
automatically changing the status of the user account from the second status value to the first statue value based on the second context.
